(19) United States
(12) Patent Application Publication
(10) Pub. No.: US 2013/0052410 A1
(43) Pub. Date: Feb. 28, 2013

(54) Reinforced Tacky Stretch Film

(71) Applicants: Konstantinos G. Gatos, Evia (GR); Anthony G. Karandinos, Crete (GR)

(72) Inventors: Konstantinos G. Gatos, Evia (GR); Anthony G. Karandinos, Crete (GR)

(73) Assignee: MEGAPLAST S.A. PACKAGING MATERIALS INDUSTRY, Attica (GR)

(21) Appl. No.: 13/393,877

(22) PCT Filed: Sep. 3, 2010
(86) PCT No.: PCT/EP10/62988

§ 371 Date: Apr. 30, 2012

(30) Foreign Application Priority Data
Sep. 4, 2009 (GB) 0915423.8

(51) Int. Cl. B32B 3/24

(52) U.S. Cl. 428/138

(57) ABSTRACT

The invention provides a tacky polyolefin stretch film suitable for flexible packaging comprising (i) a base film comprising a stretchable polymeric material having a multiplicity of perforations covering at least 25% of the total area of the base film and arranged in a series of columns along a longitudinal direction of the film, wherein the columns of perforations are separated by columns without perforations along the longitudinal direction of the film, and the perforations are staggered in a transverse direction across the film; and (ii) a multiplicity of strengthening elements comprising stretchable polymeric material wherein the elements are fixed on the base film parallel to the longitudinal direction and at least one element is situated in a column without perforations; wherein said tacky polyolefin stretch film has an inside/inside cling property of at least 18 gr.

### FIELD OF THE INVENTION

The present invention relates to a reinforced perforated stretch film having tacky characteristics, suitable for packaging applications. More particularly, the current invention is directed to a reinforced perforated stretch film of low weight, which combines increased hole-coverage and clinginess. When applying the film onto a pallet, desired pallet unitization is fulfilled, and there is advantageously no need for knots. The film of the present invention is particularly useful for machine-use packaging applications, where ventilation of the goods is essential.

### BACKGROUND

Several reinforced stretch films for packaging applications have been described in the prior art. EP 0 371 080 B1 discloses a stretch wrapping film, which comprises a primary stretch film and a lateral width reinforced with a secondary stretch film laminated thereto. Such a product fails to provide any kind of aeration to the wrapped goods of the pallet.

The combination of pallet aeration along with increased strength of the stretch film in the pulling (machine) direction has been provided by stretch films constituted by a thin base film with ventilation holes and longitudinal reinforcing elements arranged thereon. EP 0 909 721 B1 proposes that the ventilation holes be produced by transverse slits wherein the longitudinal reinforcing elements are positioned in areas of the sheet without holes, whereas in WO 2005/087608 A1 the longitudinal strips are coupled to said film additionally at its pierced portions. In US 2005/0123721 A1 the reinforcement strips are folded at least once, wherein the reinforcement of the main film can be determined either by the number of folds and/or by the number of rows of holes. US 2005/0118391 A1 discloses a reinforced stretch film which has strips with no wrinkles that reach up to the rows of holes adjacent to said strips. WO 2006/018028 A1 suggests that the width of the smooth reinforcement strip should be as large as possible but not such that it contacts the holes in the adjacent columns of holes. In WO 2007/079776 A1 the proposed packaging film combines enhanced strength in the pulling direction along with increased hole-coverage. In all of the above-mentioned reinforced perforated stretch films, regardless of their reinforcing ability or hole-coverage, clinginess is lacking. Therefore, these stretch films face difficulties during their application onto the pallet, requiring the use of knots and prolonging the working time and effort.

The natural cling of the laminated wrap film proposed in U.S. Pat. No. 5,935,681A governs the bonding of the film. Additionally, the perforations formed on the laminates are intended to assist the transfer of fluids and to reinforce the bonding of the laminates. This reinforced perforated stretch film has increased weight, mainly due to the laminated structure of the product.

The object of the present invention is to overcome the problems of the prior art mentioned above.

### SUMMARY OF THE INVENTION

In accordance with a first aspect of the invention, there is provided a tacky polyolefin stretch film suitable for flexible packaging comprising (i) a base film comprising a stretchable polymeric material having a multiplicity of perforations covering at least 25% of the total area of the base film and arranged in a series of columns along a longitudinal direction of the film, wherein the columns of perforations are separated by columns without perforations along the longitudinal direction of the film, and the perforations are staggered in a transverse direction across the film; and (ii) a multiplicity of strengthening elements comprising stretchable polymeric material wherein the elements are fixed on the base film parallel to the longitudinal direction, and at least one element is situated in a column without perforations; wherein said tacky polyolefin stretch film has an inside/inside cling property of at least 18 gr.

In accordance with a second aspect of the invention, there is provided use of a stretch film according to the first aspect of the invention to wrap goods in separate packets, or to utilize goods on a pallet.

The present invention discloses a reinforced perforated stretch film having tacky characteristics on at least one of its outer surfaces. This reinforced film of low weight and high hole-coverage is particularly useful for packaging applications where the goods need to be aerated. At the same time, the increased width of the reinforced perforated stretch film of the present invention ensures faster pallet unitization and protection of goods with lower material consumption. The latter is related to the decreased number of windings and thus, decreased film overlapping, required for wrapping a pallet. Advantageously, at the end of the wrapping application, the use of knots is unnecessary for fixing the film onto the pallet.

When applying stretch film onto a pallet, there is a need to secure the film tail in place, so that the film does not unwrap. There are pallet wrapping machines specifically designed to cut and secure the film tail using incorporated tail treatment systems, especially in high production levels. This is achieved, by using a pneumatically activated brush that smoothes and secures the film tail onto the pallet using a minimum amount of film, either by using a clip applicator that places a clip to secure the wrapping or by using a specially designed film folding device that folds the loose end to the inside of the wrapping.

Alternatively by using a hot wire to cut the film with contact and heat and securing the tail by partially melting the external film layer vertically. The use of these pallet wrappers with film tail treatment systems is not required in the present invention.

### BRIEF DESCRIPTION OF THE DRAWINGS

FIG. 1 is a top view of a portion of the base film of the invention;

FIG. 2 indicates the length and width dimensions of a Centre Hole (CH) specimen used in the Base Film Cling Method recited herein;

FIG. 3 shows a T-type CH specimen from the side during the Base Film Cling Method recited herein;

FIG. 4a is a top view of a portion of the film of the invention; and

FIG. 4b is a top view of a lateral edge portion of the film of the invention;

FIG. 5a shows schematically from the side the initial film set-up of the Product Cling Method recited herein (prior test start)

FIG. 5b shows schematically from the side the film positioning of the Product Cling Method at the measuring range (during the test)

wherein in FIG. 2

W=width of a CH specimen;

L=length of a CH specimen;

W′=width of a column without holes;

W1=width of a column with holes; and

L1=length of a hole.

### DETAILED DESCRIPTION OF THE INVENTION

The present invention discloses a reinforced perforated tacky stretch film for wrapping applications. The film comprises a base film with prominent cling characteristics, which has a multiplicity of perforations (alternatively referred to as “holes”) arranged in columns along the longitudinal (or machine) direction of the film. The holes are positioned staggered along the transverse direction of the film (that is, adjacent holes in the transverse direction are not aligned) and they cover at least 25% of the total surface area of the film. The reinforced perforated tacky stretch film has an inside/inside cling property of at least 18 gr, as determined according to the Product Cling Method (as further detailed below).

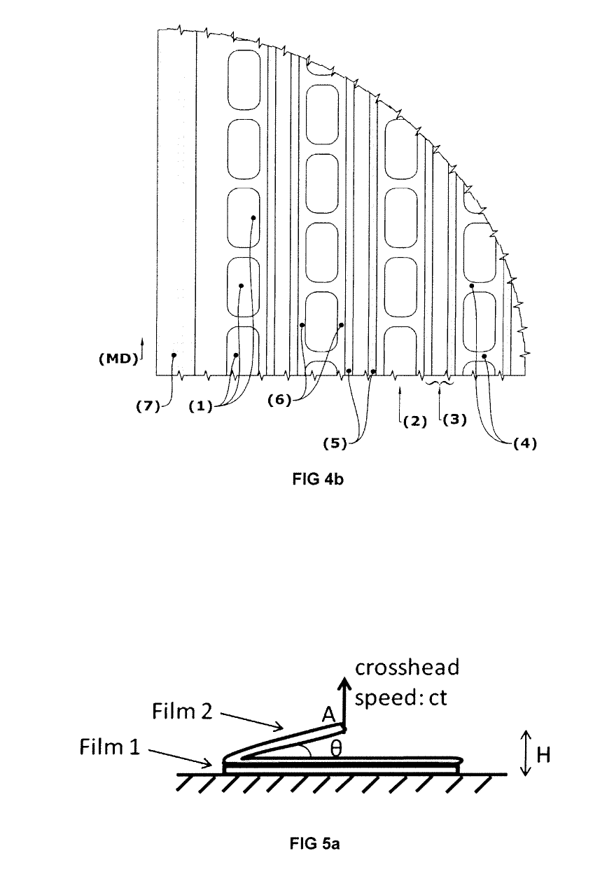

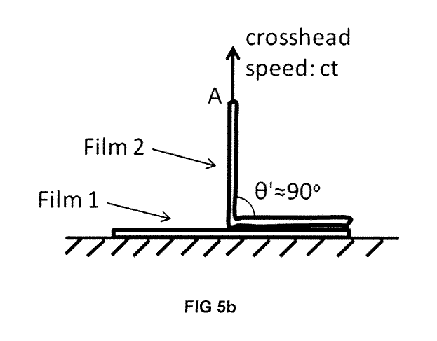

The strengthening elements of the film of the present invention are fixed on the base film parallel to the longitudinal direction of the film. Preferably, at least two of the strengthening elements are positioned between two adjacent columns of the holes of the base film. More preferably, the strengthening elements are positioned up to the edge of the adjacent holes. In certain embodiments the elements between two adjacent columns of holes are at least partly overlapping each other or more preferably one element between two adjacent columns of holes is completely overlapping the other reinforcement element. This is described in more detail in US 2009/0047468, in particular in the discussion of FIGS. 5 and 6. In another embodiment the elements between two adjacent columns of holes are not in direct contact with each other. At least one edge, of at least one of the strengthening elements, is hemmed bunched and folded longitudinally. FIGS. 4, 9 and 10 of US 2009/0047468 describe such an arrangement in more detail.

In specific embodiments each strengthening element comprises a single polymeric strip, wherein said strengthening element is not folded. In this specific embodiment the strengthening elements are even and without any folds, wherein the thickness of said strengthening elements is more than that of the base film. The thickness of said strengthening elements is preferably more than 25 μm, more preferably more than 35 μm or most preferably more than 45 μm.

Preferably, the strengthening elements form an elevated area of material on at least one surface of the base film. Preferably, the strengthening elements protrude above the plane of the surface of the base film, less than 500 μm on average, more preferably less than 300 μm and most preferably less than 200 μm, on average. Preferably, the strengthening elements protrude above the plane of the surface of the base film, greater than 25 μm, more preferably greater than 35 μm and most preferably greater than 45 μm, for example, between 30 μm and 500 μm, more preferably between 50 μm and 300 μm, more preferably between 75 μm and 150 μm, on average.

The ratio of the average width to the average thickness (height) of said strengthening elements of the current invention is more than 10:1. Preferably the ratio of the average width to the average length of said elements is greater than 1:50, for example, in the range of 1:50-1:1000, preferably in the range of 1:50-1:500, preferably in the range of 1:60-1:250, preferably in the range of 1:75-1:150.

The thickness of the strengthening elements is preferably substantially consistent along their lengths. Thus, the thickness of the strengthening elements preferably does not vary by more than ±50 μm from the average thickness, more preferably does not vary by more than ±10 μm from the average thickness, and most preferably does not vary by more than ±5 μm from the average thickness.

The height of the protrusion of the strengthening element from the base film is preferably substantially consistent along the length of the strengthening element. Thus, the height of the protrusion of the strengthening elements from the base film preferably does not vary by more than ±50 μm from the average height of the protrusion, preferably does not vary by more than ±10 μm from the average height of the protrusion, preferably does not vary by more than ±5 μm from the average height of the protrusion,

Preferably, the average thickness of the strengthening element is not less than the average thickness of the base film. Preferably none of the strengthening elements have a thickness of less than the thickness of the base film.

Preferably, each of said strengthening elements covers an area of the base film of more than 4.5 mm², preferably more than 6.0 mm², most preferably more than 8.0 mm².

Preferably, the strengthening elements of the present invention comprise or consist of co-extruded films. The components of the co-extruded films are preferably independently selected from polyolefins and polyolefin co-polymers.

Preferably, at least one strengthening element is arranged between the outermost column of perforations and the corresponding adjacent lateral edge of the base film.

Preferably, the strengthening element adjacent to the lateral edge and the lateral edge of the base film are hemmed together.

Preferably, at least one of the lateral edges of at least one of the elements is folded inwardly at least once; wherein the strengthening element is arranged on the film such that the folded lateral edges are in contact with the base film.

Preferably, both lateral edges of at least one of the elements are folded inwardly; wherein this element is arranged on the film such that the folded lateral edges are in contact with the main film.

Preferably, both lateral edges of at least one of the reinforcement elements are folded such that they overlap with one another at least once, to create a longitudinal region of the element that has at least three times the unfolded thickness of the reinforcement element.

The objective of the strengthening elements is to provide strength and tear resistance to the film. In certain embodiments the strengthening elements cover less than 25% of the total area of the film. The strengthening elements are positioned on at least one of the film's surfaces. In a preferred embodiment the strengthening elements are positioned on the cling surface of the film.

In one embodiment the strengthening elements are positioned on the slip surface of the film.

In another embodiment, the strengthening elements are fixed to an inside cling layer of the base film so as to be substantially adherent to the base film.

In another embodiment, the strengthening elements are fixed to the outside of a non-cling layer of the base film so as to be substantially adherent to the base film, preferably the strengthening elements are fixed by interfacial adhesion. In certain embodiments the strengthening elements possess cling characteristics themselves. The elements are preferably strips and are typically pressed on to the film, and reliably fixed by adhesion.

Regardless of the positioning of the strengthening elements onto the base film, as well as, the inherent cling property of both strengthening elements and base film, the reinforced perforated stretch film of the present invention has an inside/inside cling property of at least 18 gr, more preferably at least 20 gr, at least 22 gr, more preferably at least 24 gr.

In certain embodiments of this invention the strengthening elements are strips, which are monolayer or multilayer in form. Each layer generally comprises polyolefins. Alternatively non-polyolefins may be present. In preferred embodiments the strengthening element film components are polyethylene and copolymers thereof. The different layers of multilayer strengthening element film may be of the same material or different materials. Preferably the stack of the multilayer is symmetric with respect to the central layer. Preferably the multilayer is a three layer stack with an ABA or an ABC arrangement, wherein A, B and C represent the material of the layers. In specific embodiments layer B comprises a plethora of symmetrical or asymmetrical layers. In a preferred embodiment the strengthening elements are strips having in the longitudinal direction a stress of at least 8 MPa at 150% elongation, as determined according to ASTM D882-02. In another embodiment the cling layer of strengthening element exhibits a cling property of at least 40 mgr/mm as measured using the Reinforcement Element Film Cling Method.

The width of a reinforcement element is typically less than 10 mm or less than 6 mm. Preferably, it is greater than 0.5 mm wide, preferably greater than 1 mm wide, preferably greater than 2 mm wide. The reinforcement elements may or may not have equal width, but preferably, they are of equal width. Suitable reinforcement elements are described in more detail in US 2009/0047468.

Typically, the reinforcement elements and/or the film are heated before attaching the former on to the latter. This leads to polymer chain interlocking that results in interfacial adhesion, which especially occurs when a reinforcement strip is applied to the base film at an elevated temperature, for instance 50-90° C. when using a thermal bonding or laminating method. The temperature of the film, for instance, LLDPE, should be high, but below its melting point.

The base film of the reinforced perforated tacky stretch film comprises columns with holes and columns without holes. The strengthening elements of the reinforced perforated tacky stretch film are positioned on the columns without holes. A column without holes along the longitudinal direction is located between two adjacent columns of said holes. The thickness of the base film is related to the thickness of the columns without holes of the base film. The thickness of the base film is preferably less than 23 μm or more preferably less than 18 μm. The width and number of said columns without holes, as well as, of said columns with holes may vary at will. The film at the lateral columns without holes may have a width of more than one times the width of an adjacent column with holes. In preferred embodiments the lateral edge of the base film is hemmed.

Preferably, the thickness of the base film is greater than 9 μm or more preferably greater than 12 μm.

Preferably the inside/inside cling of the base film is at least 12 gr, preferably at least 18 gr. This is measured using the Base Film Cling Method.

The holes may be formed by thermal or mechanical means or any other method which has been used for such purposes in the art. In certain embodiments the borderline surrounding each hole has a greater thickness than the base film thickness. The holes may have various geometries such as circular, four-cornered, rhombus, square, ellipsoidal, rectangular, lenticular, etc. and combinations thereof, preferably circular, four-cornered and/or ellipsoidal. In certain embodiments, for increased pallet aeration, each hole is symmetrical over the longitudinal and the transverse direction. The holes may be formed by a thermal irradiation method without contracting the main film, for instance, as described in EP 0820856 A1.

Preferably, the base film of the invention comprises greater than 50% by weight of one or more polyolefins, preferably greater than 75% by weight, preferably greater than 90% by weight, preferably substantially 100% by weight of one or more polyolefins.

Preferably, the stretchable polymeric material of the strengthening elements comprises greater than 50% by weight of one or more polyolefins, preferably greater than 75% by weight, preferably greater than 90% by weight, preferably substantially 100% by weight of one or more polyolefins.

Preferably, the polyolefins used in the films of the present invention are selected from polymers and copolymers comprised primarily of olefins. For example, the polyolefin may be selected from the group consisting of polyethylene, polypropylene, polybut-ene and poly-4-methylpent-1-ene. Further examples include polymers of cycloolefins, for example of cyclopentene or norbornene.

Preferably, the polyolefin used in the film is polyethylene.

Preferably, the polyolefin used in the strengthening elements is polyethylene.

Particularly preferred films include those made of polyethylene, medium density polyethylene (MDPE), low density polyethylene (LDPE), linear low density polyethylene (LLDPE), branched low density polyethylene (BLDPE), very low density polyethylene (VLDPE) and ultra low density polyethylene (ULDPE).

The films of the present invention may also comprise mixtures of the polyolefins mentioned in the preceding paragraphs, for example, polypropylene with polyethylene (for example PP/HDPE, PP/LDPE) and mixtures of different types of polyethylene (for example LDPE/HDPE).

Particularly preferred polyolefins for use in the films and strengthening elements of the present invention are LLDPE C4, LLDPE C6, LLDPE C8, metallocene LLDPE C6 or LLDPE C8 and high pressure LDPE.

Furthermore, the films of the present invention may comprise copolymers of monoolefins with each other or with other vinyl monomers, for example ethylene/propylene copolymers, linear low density polyethylene (LLDPE) and mixtures thereof with low density polyethylene (LDPE), propylene/but-1-ene copolymers.

The base film may be a monolayer or multilayered. Each layer comprises at least one component which may be a polyolefin or a non-polyolefin. In certain embodiments the base film components are polyethylene and copolymers thereof. The different layers of multilayer base film may be of the same material or different materials. Preferably the stack of the multilayer is symmetrical with respect to the central layer. Preferably the multilayer is a three layer stack with an ABA or an ABC arrangement, wherein A, B and C represent the material of the layers. In specific embodiments layer B comprises a plethora of symmetrical or asymmetrical layers.

In preferred embodiments of the invention the base film is produced by cast or blown extrusion and co-extrusion methods. It is generally comprised of at least three layers. In certain embodiments the base film is an asymmetrical A/B/C film, wherein A stands for the slip layer, B for the core layer and C for the cling layer. Each of the layers preferably comprises a single polyolefin polymer or a mixture of polyolefins. The cling layer is preferably from about 5% to about 30%, preferably from about 5% to about 20% of the thickness of the base film. In preferred embodiments the cling layer of the base film of the present invention contains about 20% to 100% by weight of a Very Low Density Polyethylene (VLDPE), preferably 40% to 100%. Said VLDPE typically has a density ranging from 0.875 gr/cm³ to 0.905 gr/cm³, such as from 0.890 gr/cm³ to 0.905 gr/cm³ and a melt flow index ranging from 0.5 gr/10 min to 10 gr/10 min, preferably 0.5 gr/10 min to 5.0 gr/10 min, preferably from 1 gr/10 min to 4.0 gr/10 min, preferably from 2 gr/10 min to 4.0 gr/10 min, preferably from 1.5 gr/10 min to 3 gr/10 min. In certain embodiments the cling layer may also include an Ultra Low Density Polyethylene (ULDPE) in a range from 0% to 60% by weight of the cling layer. Said ULDPE has a density ranging from 0.865 gr/cm³ to 0.900 gr/cm³ such as 0.870 gr/cm³ to 0.900 gr/cm³, and a melt flow index ranging from 0.5 gr/10 min to 10.0 gr/10 min, preferably from 0.5 gr/10 min to 5 gr/10 min, preferably from 1 gr/10 min to 4.0 gr/10 min, preferably from 1.5 gr/10 min to 3 gr/10 min.

The base film is then perforated and reinforced by strengthening elements to produce the reinforced perforated stretch film of the present invention. In certain embodiments the base film is first reinforced by strengthening elements and then is perforated to produce the reinforced perforated stretch film of the present invention. In preferred embodiments the cling property of said base film is conferred by the VLDPE, ULDPE or combinations thereof. In certain embodiments the base film of the present invention has a cling property of at around 18 gr, according to the Base Film Cling Method (as further detailed below), by initially adding to the cling layer mainly VLDPE and a low amount or no ULDPE. This reinforced perforated stretch film of the present invention has an inside/inside cling property of at least 18 gr, according to the Product Cling Method. Cling may be increased by increasing the proportion of low density material such as ULDPE in the base film.

In a preferred embodiment the stretch film for flexible packaging has a weight of less than 15 gr/m and a width of at least 440 mm along the transverse direction. In certain embodiments the base film together with the strengthening elements are pre-stretched in the main (longitudinal) direction and/or in a transverse direction (perpendicular to the main direction) before or after formation of the holes.

When the base film is a multi-layer film it may be multi-layer symmetrical, for example, ABCBA structure or asymmetrical, for example ABCDE structure, wherein each of A, B, C, D and E represent a different type of layer in the multi-layer film. Preferably the stack of the multilayer is symmetrical with regard to the central layer. In specific embodiments selected layers are repeated along the thickness. Preferably the multilayer is a three layer stack with an ABA or an ABC stack, wherein A, B and C represent the different materials of the layers. In a preferred specific embodiment layer B comprises a plethora of symmetrical or asymmetrical layers.

Preferably, the reinforced thermoplastic film of the present invention comprises a base film which is an extruded multilayered stretchable or pre-stretched film. The base film may have 3+2m layers, where m is a natural number such as 0, 1, 2, 3, 4 . . . Preferably, the base film has 3, 5, 7, 9, 12, 15, 17, 19, 21, 23, 25 or 27 layers, more preferably 3, 5 or 7 layers, more preferably 3 or 5 layers, most preferably 5 layers.

Preferably, the base film has a symmetrical (ABA for a three layer film; ABCBA for a five layer film) structure, wherein each of A, B and C represent a different type of layer in the multi-layer film. Preferably the stack of the multilayer is symmetric with regards to the central layer.

A further preferred base film is one having a five layer asymmetric structure (for example ABCDE), wherein each of A, B, C, D and E represent a different type of layer in the film. In the ABCDE structure, layers B and D may be made of the same composition and/or be of the same thickness.

A further preferred base film is one having a three layer asymmetric structure (for example ABC), wherein each of A, B and C represent a different type of layer in the film.

For the above ABA layer structure, the layer A is preferably present in the range of 5-30% of the base film thickness, preferably 5-20%, preferably 10-15% thereof. The layer B is preferably present in the range of 40-90% of the base total film thickness, preferably 60-90%, preferably 70-80% thereof.

For the above ABC layer structure, the layer A is preferably present in the range of 5-30% of the base film thickness, preferably 5-20%, preferably 10-15% thereof. The layer B is preferably present in the range of 40-90% of the base total film thickness, preferably 60-90%, preferably 70-80% thereof. The layer C is preferably present in the range of 5-30% of the base total film thickness, preferably 5-20%, preferably 10-15% thereof.

For the above ABC layer structure, the layer A is preferably a slip layer, the layer B is preferably a core layer and the layer C is preferably a cling layer.

For the above ABA layer structure, preferably the density of layer B>layer A.

For the above ABC layer structure, preferably the density of layer A>layer C.

For the above ABC layer structure, preferably the major melting peak of layer A>layer C. For the above ABC layer structure, preferably the density of layer A≧layer B>layer C. For the above ABC layer structure, preferably the major melting peak of layer A≧layer B>layer C.

The major melting peak refers to the major peak of the melting curve in a heat-flow versus temperature graph of said polymer obtained by means of Differential Scanning calorimetry (DSC). The major melting peak was calculated using a Mettler Toledo DSC822^{e} model at a heating rate of 10° C./min under nitrogen atmosphere. Sample of 10-15 mg of said polymer was heated up to 190° C. followed by its cooling at around −70° C. with a cooling rate of 10° C./min under nitrogen atmosphere. During the second heat up to the melt, the major melting peak was identified and its position upon the temperature scale was reported.

For the above ABC layer structure, preferably the density of layer A is greater than 0.916 g/cm³; the density of layer B is preferably in the range of 0.916-0.938 g/cm³, and the density of layer C is preferably in the range of 0.870 g/cm³ to 0.905 g/cm³.

For the above ABC layer structure, preferably layer A comprises greater than 50% by weight of LLDPE (Linear Low Density Polyethylene), preferably greater than 75%, preferably greater than 90%, preferably substantially 100% LLDPE. Preferably, the LLDPE of layer A, and where other materials to LLDPE are present, layer A itself, has a density of greater than 0.916 g/cm³, preferably 0.916-0.938 g/cm³, preferably about 0.923 g/cm³. Preferably, the LLDPE of layer A, and where other materials to LLDPE are present, layer A itself has a major melting peak in the range of 95° C.-145° C., preferably 105° C.-130° C., more preferably about 120° C.

For the above ABC layer structure, preferably layer B comprises greater than 50% by weight of LLDPE (Linear Low Density Polyethylene), preferably greater than 75%, preferably greater than 90%, preferably substantially 100% LLDPE. Preferably, the LLDPE of layer B, and where other materials to LLDPE are present, layer B itself has a density in the range of 0.916-0.938 g/cm³, preferably 0.918-0.922 g/cm³, preferably about 0.920 g/cm³. Preferably, the LLDPE of layer B, and where other materials to LLDPE are present, layer B itself has a major melting peak in the range of 90° C.-130° C., preferably 95° C.-125° C., more preferably about 117° C.

For the above ABC layer structure, preferably layer C comprises greater than 20% by weight of VLDPE or ULDPE (Very Low Density Polyethylene or Ultra Low Density Polyethylene), or a mixture thereof, preferably greater than 50%, preferably greater than 75%, preferably substantially 100% VLDPE or ULDPE. Most preferably, layer C comprises ULDPE. Preferably, the ULDPE of layer C, and where other materials to ULDPE are present, layer C itself has a density in the range of 0.870 g/cm³ to 0.890 g/cm³, preferably 0.875-0.885 g/cm³, preferably about 0.880 g/cm³. Preferably, the VLDPE of layer C, and where other materials to VLDPE are present, layer C itself has a density in the range of 0.870 g/cm³ to 0.905 g/cm³, preferably 0.900-0.902 g/cm³, preferably about 0.902 g/cm³. Preferably, the VLDPE of layer C, and where other materials to VLDPE are present, layer C itself has a major melting peak in the range of 70° C.-130° C., preferably 80° C.-125° C., more preferably about 100° C. Preferably, the ULDPE of layer C, and where other materials to ULDPE are present, layer C itself has a major melting peak in the range of 50° C.-110° C., preferably 60° C.-100° C., more preferably about 70° C. The cling properties can be increased by increasing the percentage of ULDPE in the cling layer.

For the above ABCDE layer structure or the ABCDA structure or the ABCBE structure or the ABCBA structure, the layer A is preferably present in the range of 2-30% of the base film thickness, preferably 5-15% thereof. The layer B is preferably present in the range of 5-40% of the base film thickness, preferably 10-30% thereof. The layer C is preferably present in the range of 20-80% of the base film thickness, preferably 30-60% thereof, more preferably 35-55% thereof. The layer D (where present) is preferably present in the range of 5-40% of the base film thickness, preferably 10-30% thereof. The layer E (where present) is preferably present in the range of 2-30% of the base film thickness, preferably 5-15% thereof.

For the above ABCDE layer structure, the layer A is preferably a slip layer, the layer B is preferably an intermediate layer and the layer C is preferably a core layer, layer D is an intermediate layer and layer E is preferably a cling layer. Preferably, the ULDPE of layer E, and where other materials to ULDPE are present, layer E itself has a major melting peak in the range of 50° C.-110° C., preferably 60° C.-100° C., more preferably about 70° C. The cling properties can be increased by increasing the percentage of ULDPE in the cling layer.

For the above ABCDE layer structure, preferably the density of layer A>layer E. For the above ABCDE layer structure, preferably the major melting peak of layer A>layer E. For the above ABODE layer structure, preferably the density of layer A≧layer C>layer E. For the above ABODE layer structure, preferably the major melting peak of layer A≧layer C>layer E.

For the above ABODE layer structure, layer A preferably has a density in the range of 0.916-0.938 g/cm³, layer B preferably has a density of greater than 0.916 g/cm³, layer C preferably has a density of greater than 0.916 g/cm³, layer D preferably has a density of greater than 0.916 g/cm³, layer E preferably has a density in the range of 0.870 g/cm³ to 0.905 g/cm³.

For the above ABODE layer structure, preferably layer A comprises greater than 50% by weight of LLDPE (Linear Low Density Polyethylene), preferably greater than 75%, preferably greater than 90%, preferably substantially 100% LLDPE. Preferably, the LLDPE of layer A, and where other materials to LLDPE are present, layer A itself has a density of greater than 0.916 g/cm³, preferably 0.916-0.938 g/cm³, preferably about 0.923 g/cm³. Preferably, the LLDPE of layer A, and where other materials to LLDPE are present, layer A itself has a major melting peak in the range of 95° C.-145° C., preferably 105° C.-130° C., more preferably about 120° C.

For the above ABODE layer structure, preferably layer B may be any polyolefin, preferably a polyethylene, and preferably comprises greater than 50% by weight of LLDPE (Linear Low Density Polyethylene), preferably greater than 75%, preferably greater than 90%, preferably 100% LLDPE. In certain embodiments layer B is the same composition and/or thickness as layer D, as described herein.

For the above ABODE layer structure, preferably layer C comprises greater than 50% by weight of LLDPE (Linear Low Density Polyethylene), preferably greater than 75%, preferably greater than 90%, preferably substantially 100% LLDPE. Preferably, the LLDPE of layer C, and where other materials to LLDPE are present, layer C itself has a density in the range of 0.916-0.938 g/cm³, preferably 0.918-0.922 g/cm³, preferably about 0.920 g/cm³. Preferably, the LLDPE of layer C, and where other materials to LLDPE are present, layer C itself has a major melting peak in the range of 90° C.-130° C., preferably 95° C.-125° C., more preferably about 117° C.

For the above ABCDE layer structure, preferably layer D may be any polyolefin, preferably a polyethylene, and preferably comprises greater than 50% by weight of LLDPE (Linear Low Density Polyethylene), preferably greater than 75%, preferably greater than 90%, preferably 100% LLDPE. In certain embodiments layer D is the same composition and/or thickness as layer B, as described herein.

For the above ABCDE layer structure, preferably layer E comprises greater than 20% by weight of VLDPE or ULDPE (very Low Density Polyethylene or ultra Low Density Polyethylene), preferably greater than 50%, preferably greater than 75%, preferably substantially 100% VLDPE or ULDPE. Most preferably, layer E comprises substantially ULDPE. Preferably, the ULDPE of layer E, and where other materials to ULDPE are present, layer E itself has a density in the range of 0.870 g/cm³ to 0.890 g/cm³, preferably 0.875-0.885 g/cm³, preferably about 0.880 g/cm³. Preferably, the VLDPE of layer E, and where other materials to VLDPE are present, layer E itself has a density in the range of 0.890 g/cm³ to 0.905 g/cm³, preferably 0.900-0.902 g/cm³, preferably about 0.902 g/cm³. Preferably, the VLDPE of layer E, and where other materials to VLDPE are present, layer E itself has a major melting peak in the range of 70° C.-130° C., preferably 80° C.-125° C., more preferably about 100° C. Preferably, the ULDPE of layer E, and where other materials to ULDPE are present, layer E itself has a major melting peak in the range of 50° C.-110° C., preferably 60° C.-100° C., more preferably about 70° C. The cling properties can be increased by increasing the percentage of ULDPE in the cling layer.

For the above ABCDE layer structure, B, C and D can comprise nanolayers. The technology of producing nanolayers is described in more detail in US2009/0104424.

For the above ABC layer structure, preferably layer A comprises more than one layer. Preferably layer A is comprised of 1 or 2 or 3 or up to n layers, wherein n belongs to natural numbers. Thus, layer A is comprised of the layers A₁, A₂, A₃, up to Aₙ, wherein n belongs to natural numbers. The layers A₁ up to Aₙ are preferably produced by separate extruders, by the same extruder or by any combination thereof. Preferably layer A₁ is the outer layer of layer A, wherein the materials used in layer A₁ are these compounded in layer A of an ABC layer stack. Preferably the density of layer A₁ is that of said layer A of an ABC layer stack. Preferably the major melting peak of the materials compounded in layer A₁ is that of said layer A of an ABC layer stack.

For the above ABC layer structure, preferably layer B comprises more than one layer. Preferably layer B is comprised of 1 or 2 or 3 or up to k layers, wherein k belongs to natural numbers. Thus, layer B is comprised of the layers B₁, B₂, B₃, up to Bₖ, wherein k belongs to natural numbers. The layers B₁ up to Bₖ are preferably produced by separate extruders, by the same extruder or by any combination thereof.

For the above ABC layer structure, preferably layer C comprises more than one layer. Preferably layer C is comprised of 1 or 2 or 3 or up to n layers, wherein n belongs to natural numbers. Thus, layer C is comprised of the layers C₁, C₂, C₃, up to Cₙ, wherein n belongs to natural numbers. The layers C₁ up to Cₙ are preferably produced by separate extruders, by the same extruder or by any combination thereof. Preferably layer C₁ is the outer layer of layer C, wherein the materials used in layer C₁ are these compounded in layer C of an ABC layer stack. Preferably the density of layer C₁ is that of said layer C of an ABC layer stack. Preferably the major melting peak of the materials compounded in layer C₁ is that of said layer C of an ABC layer stack.

For the above (A₁, A₂, A₃, up to Aₙ)(B₁, B₂, B₃, up to Bₖ)(Cₙ, Cₙ₋₁, Cₙ₋₂, down to C-₁) multi layer stack, preferably the materials used in any layer A₂ up to Aₙ are these compounded in any layer of an ABC layer stack. Preferably the density of any layer A₂ up to Aₙ is that of any layer of an ABC layer stack. Preferably the major melting peak of the materials compounded in any layer A₂ up to Aₙ is that of any layer of an ABC layer stack.

For the above (A₁, A₂, A₃, up to Aₙ)(B₁, B₂, B₃, up to Bₖ)(Cₙ, Cₙ₋₁, Cₙ₋₂, down to C-₁) multi layer stack, preferably the materials used in any layer B₁ up to Bₖ are these compounded in any layer of an ABC layer stack. Preferably the density of any layer B₁ up to Bk is that of any layer of an ABC layer stack. Preferably the major melting peak of the materials compounded in any layer B₁ up to Bₖ is that of any layer of an ABC layer stack.

For the above (A₁, A₂, A₃, up to Aₙ)(B₁, B₂, B₃, up to Bₖ)(Cₙ, Cₙ₋₁, Cₙ₋₂, down to C-₁) multi layer stack, preferably the materials used in any layer Cₙ down to C₂ are these compounded in any layer of an ABC layer stack. Preferably the density of any layer Cₙ down to C₂ is that of any layer of an ABC layer stack. Preferably the major melting peak of the materials compounded in any layer Cₙ down to C₂ is that of any layer of an ABC layer stack. The innovative combination of cling, hole-coverage, weight, strengthening element-coverage and strength that the reinforced perforated cling stretch film of this invention possesses renders it suitable for packaging machine use applications.

In a further embodiment, there is a tacky polyolefin stretch film suitable for flexible packaging comprising:
(i) a base film comprising a stretchable polymeric material having a multiplicity of perforations covering at least 25% of the total area of the base film and arranged in a series of columns along a longitudinal direction of the film, wherein the columns of perforations are separated by columns without perforations along the longitudinal direction of the film, and the perforations are staggered in a transverse direction across the film, wherein the base film has an inside/inside cling property of at least 12 gr; and
(ii) a multiplicity of strengthening elements comprising stretchable polymeric material wherein the elements are fixed on the base film parallel to the longitudinal direction and at least one element is situated in a column without perforations.

This further embodiment may incorporate any of the preferred features disclosed in relation to other embodiments. In particular, this further embodiment may incorporate any of the features of the claims. In this further embodiment, the base film preferably has an inside/inside cling property of at least 18 gr.

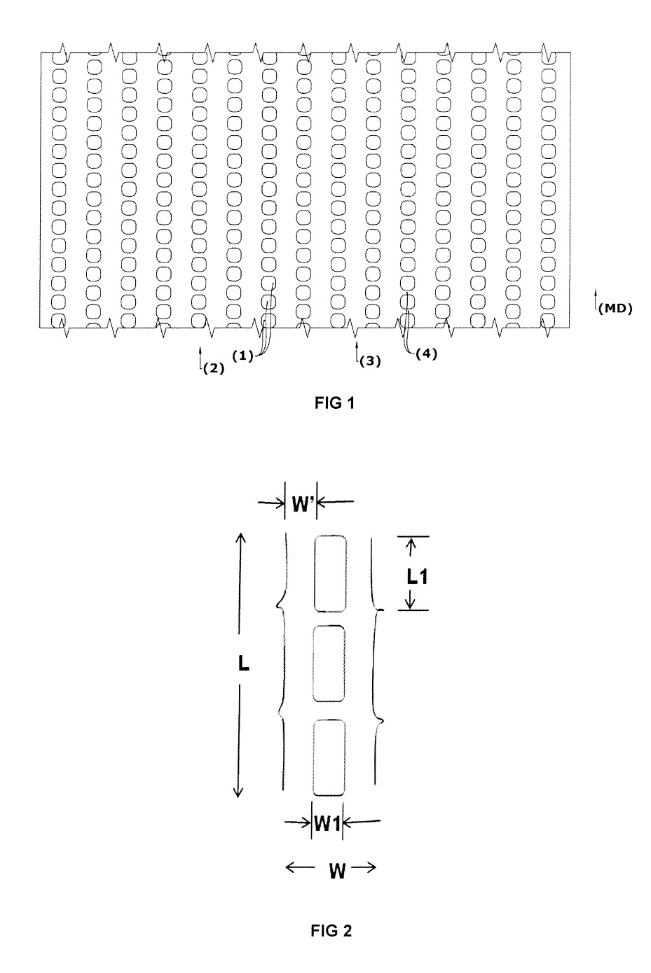

In FIG. 1 a certain embodiment of a base film of said reinforced tacky stretch film is depicted. Said base film has a multiplicity of holes (1) arranged along the machine direction (MD) in columns (2) wherein two adjacent columns of perforations are separated with a column without perforations (3). Adjacent perforations along the MD are separated with a film portion (4). In FIG. 1 the staggered positioning of the perforations across the transverse direction is also presented.

In FIG. 2, a Centre-Hole (CH) specimen is shown. This portion is taken from the base film of a specific embodiment of said film of the present invention.

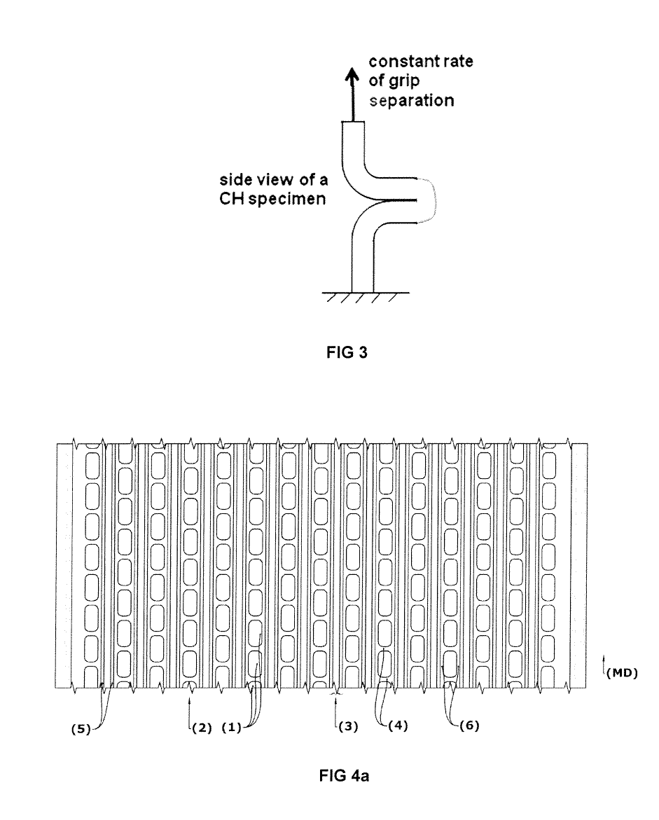

FIG. 3 depicts from the side the configuration of a T-type CH specimen during the Base Film Cling Method recited herein, wherein the direction of the grip separation is also given. The configuration of a T-type specimen is also used for the Reinforcement Element Cling Method

In FIG. 4a a preferred embodiment of the reinforced tacky stretch film of the present invention is depicted. The perforations (1) are aligned along the MD in columns (2), wherein adjacent columns of perforations (2) of said film are separated by columns without perforations (3). On said columns without perforations (3) two strengthening elements (5) are fixed side by side along the MD. The positioning of the strengthening elements (5) close to the edge of adjacent perforations defines the size of the portion of film therein (6).

In FIG. 4b, a top view of a lateral edge portion of the embodiment shown in FIG. 4a is depicted. The width of the lateral column without perforations is greater than the width of the adjacent column with perforations. In this specific embodiment, one strengthening element is arranged between the outermost column of perforations (2) and the corresponding lateral edge of the base film. Said strengthening element adjacent said lateral edge of the base film and the lateral edge of the base film are hemmed together (7).

FIG. 5a depicts schematically from the side the initial film set-up of the Product Cling Method (prior test start). Film 1 lays fixed onto a flat surface wherein Film 2 is positioned onto Film 1. A free edge (along the TD) of Film 2 is fixed at a grip (point A), wherein said grip is set at a height H from said flat surface.

FIG. 5b depicts schematically from the side the film positioning of the Product Cling Method at the measuring range (during the test), wherein the direction of the grip separation is also given. Note that therein angle θ appears to be 90°.

The following non-limiting examples demonstrate some unexpected results regarding the combination of hole-area coverage, weight, reinforcement element-area coverage, width and clinginess obtained with the reinforced perforated cling stretch film of the present invention.

### General Methods

To determine the weight of the reinforced perforated tacky film, one meter length of the film is cut and weighed. This value is preferably reported in grams per meter (grim).

The evaluation of the hole-area coverage for perforated films is given by the ratio of the hole-area appearing in half meter perforated film over the area of the whole of the perforated film for the same unit length. The hole-area coverage is expressed in percentage (%).

The evaluation of the strengthening element-area coverage for reinforced films is given by the ratio of the strengthening element-area appearing in half meter reinforced film over the area of the whole the film for the same unit length. The strengthening element-area coverage is expressed in percentage (%).

The ambient temperature when carrying out the experiments was 23° C. and the humidity was 50%.

### Base Film Cling Method

This method is for measuring the inside-inside cling property of the cling side of the perforated base film prior to the addition of the reinforcement elements. The method developed and used for determining the cling property for perforated films is as follows:

### A. Equipment

An Instron (Model 3365) universal testing machine with a constant rate of grip separation equipped with a load cell of 100N was used.

### B. Test Specimens

The roll to be tested must have at least three outer wraps removed just prior to sample selection. Without touching the film test surface, the film was placed on a glass cutting surface being cautious not to create wrinkles. The holes on the examined perforated films lay staggered in columns along the machine direction (MD), wherein columns without holes lay between the said columns of holes.

Using a razor blade or sharp scissors, specimen having a width of two adjacent rows without holes and one row of holes in-between, along the transverse direction (TD), is cut. This type of sample according to Megaplast's designation is called thereon as Centre Hole specimen (CH). In cases that the lateral column without holes at the edge of the film along the TD has a width of more than three times the width of the narrower column without holes, then a specimen having a width of two times the width of the narrower column without holes is additionally cut and follows accordingly the below-mentioned procedure.

The length of the specimens along the (MD), for evaluating the cling property, is 220 mm. Each specimen has a width along the TD, which corresponds to a specific fraction of each initial film/roll width. The specimen prior to testing was prepared by folding along the MD on itself. Using the wide side of a paint brush and moderate pressure and speed, a length of 80 mm folded specimen with five strokes was brushed. The overlapping created a contact of the same side of the film, which was chosen to be the inside/cling layer of the film—therefore the current method measures the so-called ‘same side cling’.

### C. Test Operation

The free sides of the folded specimen along the TD were clamped on the testing machine creating a T-type sample configuration. The grip distance was 50 mm and the specimen was pulled apart with a cross-head speed of 150 mm/min. During the test, the plane of the overlapped surfaces remained vertical to the load direction. When the overlapped surfaces were unfolded, the test was terminated.

### D. Calculations

The force required to unfold the same side of the overlapped perforated specimen is a measure of the same side cling. Monitoring the necessary force to peel-off the overlapped perforated specimen versus the extension, an S-type curve and thus, a force-plateau is obtained. The average force at the plateau between 20 and 100 mm of the extension provides the same side cling per measured specimen. The cumulative same side cling of a perforated film, with fixed width of columns with and without holes, is given by the ratio of the measured/plateau force to unfold the perforated specimen over the film width fraction that corresponds to said perforated CH specimen. In cases that the width of columns with holes and the width of columns without holes vary along the transverse direction, the cumulative same side cling is the summation of the cumulative same side clings from each region with repeated structure. The same holds for the lateral columns without holes at the edge of the film along the TD in case that they have been initially considered. The cumulative same side cling of each perforated film is reported in units of force, preferably grams force.

### Reinforcement Element Film Cling Method

This method is used to measure the cling property of the film which is used to make the reinforcement elements before the film is cut up to make the reinforcement elements. Preferably, the cling property of the side of the film which will not be adhered to the base film is measured. The method developed and used for determining the cling property of a stretch film and more specific of the strengthening element stretch film is as follows:

### A. Equipment

An Instron (Model 3365) universal testing machine with a constant rate of grip separation equipped with a load cell of 100N was used.

### B. Test Specimens

The roll to be tested must have at least three outer wraps removed just prior to sample selection. Without touching the film test surface, the film was placed on a glass cutting surface being cautious not to create wrinkles. Using a razor blade or sharp scissors, a specimen having a width of 25 mm, along the transverse direction (TD) and a length of 220 mm along the (MD), is cut. The specimen prior to testing was prepared by folding along the MD on itself. Using the wide side of a paint brush and moderate pressure and speed, a length of 80 mm folded specimen with five strokes was brushed. The overlapping created a contact of the same side of the film, which was chosen to be the inside/cling layer of the film—therefore the current method measures the so-called ‘same side cling’.

### C. Test Operation

The free sides of the folded specimen along the TD were clamped on the testing machine creating a T-type sample configuration. The grip distance was 50 mm and the specimen was pulled apart with a cross-head speed of 150 mm/min. During the test, the plane of the overlapped surfaces should remain vertical to the load direction. When the overlapped surfaces were unfolded, the test was terminated.

### D. Calculations

The force required to unfold the same side of the overlapped specimen is a measure of the same side cling. Monitoring the necessary force to peel-off the overlapped specimen versus the extension, an S-type curve and thus, a force-plateau is obtained. The average force at the plateau between 20 and 100 mm of the extension provides the same side cling per measured specimen. The same side cling of a 25 mm specimen is reported in units of force per unit width, preferably milligrams force per mm (mgr/mm).

### Product Cling Method

This method is used to measure the cling property of the product of the invention, that is the reinforced perforated tacky polyolefin stretch film. The cling property of the cling side of the film is measured. This may or may not be the side of the film with the reinforcement elements. The method developed and used for determining the cling property of a stretch film and more specific of a reinforced perforated stretch film is as follows:

### A. Equipment

An Instron (Model 3365) universal testing machine with a constant rate of grip separation equipped with a load cell of 100N was used.

### B. Test Specimens

The roll to be tested must have at least three outer wraps removed just prior to sample selection. Without touching the film test surface, the film was placed on a glass cutting surface being cautious not to create wrinkles. Using a razor blade or sharp scissors, a specimen having a width that is the width of the film along the transverse direction (TD) and a length of 250 mm along the (MD) is cut. This specimen is designated on FIG. 5 as Film 1. Moreover, a specimen having a width that is the width of the film along the transverse direction (TD) and a length of 300 mm along the (MD) is cut. This specimen is designated on FIG. 5 as Film 2. Film 1 was fixed onto a flat surface (width×length: 55 cm×12 cm) wherein Film 2 is positioned onto Film 1, such that the one free edge along the TD of Film 2 to be able to expand beyond the flat surface. Using the wide side of a paint brush and moderate pressure and speed, the overlaid specimens with five strokes were brushed. The overlapping was chosen to create a contact of the inside cling layer of the film—therefore the current method measures the so-called ‘inside/inside cling’.

### C. Test Operation

The long free edge (along the TD) of Film 2 was clammed on the testing machine. The distance (H) of the grip from the flat surface was 50 mm and Film 2 was pulled apart with a cross-head speed of 150 mm/min. During the test, angle θ was increasing. When angle θ became obtuse (more than 90°), the test was terminated.

### D. Calculations

The force required to unfold the surfaces of the overlapped specimens when angle θ is 90° is a measure of the cling property. Monitoring the necessary force to peel-off the overlapped specimens (as angle θ increases) versus the extension, a force-extension graph is obtained. If the film surfaces that come into contact are the inside ones, then the average force when angle θ reaches 90° (or actually in this application, when angle θ is at the range of about 90±3° provides the inside/inside cling of the film. The inside/inside cling of a film is reported in units of force, preferably grams force (gr).

Note that the above-mentioned modified 90° peel-off test apart from the inside/inside cling is able to measure the inside/outside cling, as well as, the outside/outside cling of a reinforce perforated stretch film, accordingly.

### Example 1

Reinforced perforated cling stretch film is provided, wherein the perforations cover 28% per unit area of said film and the weight of said film is 13.4 gr/m. The strengthening elements cover 24% per unit area of said film and the width of said film is 460 mm. The cumulative same side cling of the unreinforced perforated base film of said reinforced film was tested according to the Base Film Cling Method and was found to be 20.5 gr. The inside/inside cling of said reinforced perforated film according to the Product Cling Method was found to be 19.5 gr.

The following comparative examples of reinforced perforated films selected from prior art present prominent characteristics and set forth to illustrate the present invention without diminishing or limiting its scope.

### Comparative Example 1

Sample A is a reinforced perforated stretch film of the prior art, wherein the perforations cover 32% per unit area of said film and the weight of said film is 15.9 gr/m. The strengthening elements cover 50% per unit area of said film and the width of said film is 460 mm. The inside/inside cling of said reinforced perforated film according to the Product Cling Method was found to be 4.5 gr.

### Comparative Example 2

Sample B is a reinforced perforated stretch film of the prior art, wherein the perforations cover 11% per unit area of said film and the weight of said film is 16.5 gr/m. The strengthening elements cover 16% per unit area of said film and the width of said film is 450 mm. The inside/inside cling of said reinforced perforated film according to the Product Cling Method was found to be 13.2 gr.

### Comparative Example 3

Further tests were performed on perforated stretch films of the invention and the prior art. The weight, the percentage of film surface area covered by perforations and the inside/inside cling as per the Product Cling Method were measured, and the results are summarised in Table 1.

The first three films in the table are those of the invention, and the rest are those of the prior art.

TABLE 1

| | | | Sholes/ | inside/ |
|---|---|---|---|---|
| | | Weight | Sfilm | inside cling |
| Film | Company | (gr/m) | (%) | (gr) |
| AOS Experimental No. 1 | Megaplast | 13.4 | 28 | 19.5 |
| AOS Experimental No. 2 | Megaplast | 9.0 | 38 | 20.4 |
| AOS Experimental No. 3 | Megaplast | 10.9 | 31 | 25.0 |
| Air-O-Tite | Megaplast | 15.9 | 32 | 4.5 |
| N/1 | Galloplastik | 16.5 | 11 | 13.2 |
| Clima Wrap | Heikaus | 6.6 | 11 | 9.8 |
| Stretch Film | Megaplast | 11.2 | 35 | 15 |

Various changes may be made to the details of the above-described embodiments of the current invention without departing from the underlying principles thereof. The scope of the present invention is determined only by the following claims.

1. A tacky polyolefin stretch film suitable for flexible packaging comprising
(i) a base film comprising a stretchable polymeric material having a multiplicity of perforations covering at least 25% of the total area of the base film and arranged in a series of columns along a longitudinal direction of the film, wherein the columns of perforations are separated by columns without perforations along the longitudinal direction of the film, and the perforations are staggered in a transverse direction across the film; and
(ii) a multiplicity of strengthening elements comprising stretchable polymeric material wherein the elements are fixed on the base film parallel to the longitudinal direction and at least one element is situated in a column without perforations;
wherein said tacky polyolefin stretch film has an inside/inside cling property of at least 18 gr.

2. A stretch film according to claim 1, wherein the perforations cover less than 60% of the total surface area of the base film, preferably less than 50% of the total surface area of the base film, most preferably 25-40% of the total surface area of the base film.

3. A stretch film according to any of claim 1, wherein the width of the film is no less than 400 mm and is preferably between 430-500 mm.

4. A stretch film according to claim 1, wherein the base film has a thickness of less than 23 pm.

5. A stretch film according to claim 1, wherein each perforation has a border which is of greater thickness than the average base film thickness.

6. A stretch film according to claim 1, characterized in that each lateral edge of the base film is hemmed.

7. A stretch film according to claim 1, which comprises a mixture of ethylene copolymers.

8. A stretch film according to claim 1, wherein the elements comprise a mixture of ethylene copolymers.

9. A stretch film according to claim 1, wherein the strengthening elements comprise A-X-A symmetrically multilayered ethylene copolymers.

10. A stretch film according to claim 1, wherein the strengthening elements comprise A-X-C asymmetrically multilayered ethylene copolymers.

11. A stretch film according to claim 1, wherein all columns without perforations have a strengthening element.

12. A stretch film according to claim 1, wherein the elements are thermally laminated to the base film.

13. A stretch film according to claim 11 wherein the elements between two adjacent columns of perforations are not in direct contact with each other.

14. A stretch film according to claim 11 wherein the elements between two adjacent columns of perforations are at least partly overlapping each other.

15. A stretch film according to claim 1, wherein the cling layer of strengthening element exhibits a cling property of at least 40 mgr/mm.

16. A stretch film according to claim 1, wherein the film has a weight of less than 16 gr/m, preferably less than 15 gr/m most preferably less than 14 gr/m.

17. A stretch film according to claim 1, wherein the strengthening elements comprise at least one reinforcement strip made of a stretchable polymeric film material.

18. A stretch film according to claim 1, wherein the base film is asymmetrical A/B/C film, wherein A is a slip layer, B is a core layer and C is a cling layer.

19. A stretch film according to claim 18 wherein the cling layer of the base film comprises 40 to 100% by weight of a very low density polyethylene (VLDPE).

20. A stretch film according to claim 17, wherein the cling layer of the base film further comprises ultra low density polyethylene (ULDPE) in an amount up to 60% by weight of the cling layer.

21. A stretch film according to claim 1, wherein the inside/inside cling property of the base film is at least 12 gr, preferably at least 18 gr.

22.-23. (canceled)
